(19) United States
(12) Patent Application Publication
(10) Pub. No.: US 2016/0132175 A1
(43) Pub. Date: May 12, 2016

(54) OPTICAL FILM AND TOUCH CONTROLLED DISPLAY APPARATUS USING THE SAME

(71) Applicant: Innolux Corporation, Miao-Li County (TW)

(72) Inventors: Bo-Chin Tsuei, Miao-Li County (TW); Jian-Cheng Chen, Miao-Li County (TW)

(21) Appl. No.: 14/934,181

(22) Filed: Nov. 6, 2015

(30) Foreign Application Priority Data
Nov. 7, 2014 (TW) 103138657

(51) Int. Cl. G06F 3/041; G09G 3/20; G09G 3/36; G09G 3/32; G06F 3/044; G06F 3/047

(52) U.S. Cl. CPC G06F 3/0416; G06F 3/0412; G06F 3/044; G06F 3/047; G09G 3/36; G09G 3/3208; G09G 3/2092; G06F 2203/04112; G06F 2203/04103

(57) ABSTRACT

An optical film and a touch controlled display apparatus using the same are disclosed. The optical film includes a substrate, a first electrode and a plurality of parallel conductive wires. The substrate has a transparent region having a first area and a second area. The first electrode is disposed in the first area, and has a width substantially ranging from 1˜30 micrometers (μm). The parallel conductive wires are disposed in the second area. At least two adjacent parallel conductive wires have a distance substantially ranging from 50˜300 nanometers (nm).

This application claims the benefit of Taiwan application Serial No. 103138657, filed Nov. 7, 2014 the subject matter of which is incorporated herein by reference.

### BACKGROUND OF THE INVENTION

1. Field of the Invention

The disclosure relates in general to an optical film and a touch controlled display apparatus using the same, and more particularly to an optical film having nano wire grid structure and a touch controlled display apparatus using the same.

2. Description of the Related Art

In recent years, the development of a display apparatus equipped with a touch panel is a huge breakthrough in the history of technology. Typically, the touch panel is adhered to a display medium to form the display apparatus. However, the touch panel has a certain thickness. If the touch panel and the display are directly assembled together, the thickness of the display apparatus will be increased and the display quality of the display apparatus may be inversely affected. Therefore, how to integrate touch control and display functions in a thin type display apparatus without affecting its display quality has become a prominent task for people in the technology field.

Therefore, it is necessary to provide an advanced optical film and a touch controlled display apparatus using the same to obviate the drawbacks and problems encountered from the prior art.

### SUMMARY OF THE INVENTION

On aspect of the present disclosure is directed to an optical film including a substrate, a first electrode and a plurality of parallel conductive wires. The substrate has a transparent region having a first area and a second area. The first electrode is disposed in the first area, and has a width substantially ranging from 1˜30 micrometers (μm). The parallel conductive wires are disposed in the second area. At least two adjacent parallel conductive wires have a distance substantially ranging from 5˜300 nanometers (nm).

According to another aspect of the present disclosure, a touch controlled display apparatus including an optical film and a display medium is disclosed. The optical film includes a substrate, a first sensing electrode and a plurality of parallel conductive wires. The substrate has a surface, and the surface has a touch region including a first area and a second area. The first electrode is disposed in the first area, and has a width substantially ranging from 1˜30 micrometers (μm). The parallel conductive wires are disposed in the second area. At least two adjacent parallel conductive wires define a distance, and at least two central points of two adjacent distance have a pitch substantially ranging from 5˜300 nm. The display medium has a light output surface parallel to the surface of the substrate.

According to the above disclosure, the embodiments of the present disclosure discloses an optical film having a nano wire grid structure and a touch controlled display apparatus using the same. The sensing electrodes of the touch panel are integrated into the optical film having the nano wire grid structure, such that the optical film can both provide a touch-sensing function and reflect polarized light. In other words, the optical film can serve as a touch panel element and an absorbing polarizer of a display medium at the same time.

When the touch panel using the optical film is integrated with the display medium to form a touch controlled display apparatus, a conventional polarizer disposed outside the light output surface of the display medium can be omitted. Such that, not only the manufacturing cost for forming the touch controlled display apparatus but also the thickness of the touch controlled display apparatus can be reduced by omitting the use of the polarizer. Furthermore, because the optical film having the nano wire grid structure is a reflective polarizer that, in comparison to an absorbing polarizer, has a polarized reflectance greater than that of the absorbing polarizer. The optical film having the nano wire grid structure is less likely to absorb the light to develop thermal degeneration, and can therefore assure the display quality of the touch controlled display apparatus.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1A is a top view illustrating an optical film used in a touch controlled display apparatus according to an embodiment of the present disclosure;

FIG. 1B illustrates a cross-sectional view of the optical film taken along a tangent line S1 depicted in FIG. 1A;

FIG. 1C is an enlarged partial view illustrating in detail the structure depicted in FIG. 1A;

FIG. 2 is a cross-sectional view illustrating a touch panel according to an embodiment of the present disclosure;

FIG. 2′ is a cross-sectional view illustrating a touch panel according to another embodiment of the present disclosure;

FIG. 3 is a cross-sectional view illustrating a touch LCD according to an embodiment of the disclosure;

FIG. 4 is a cross-sectional view illustrating a touch OLED display according to another embodiment of the present disclosure;

FIG. 5A is a cross-sectional view illustrating an optical film used in a touch controlled display apparatus according to another embodiment of the disclosure;

FIG. 5B illustrates a cross-sectional view of the optical film taken along a tangent line S5 depicted in FIG. 5A;

FIG. 6 is a cross-sectional view illustrating a touch panel according to another embodiment of the present disclosure;

FIG. 6′ is a cross-sectional view illustrating a touch LCD according to yet another embodiment of the present disclosure;

FIG. 7 is a cross-sectional view illustrating a touch LCD according to yet another embodiment of the present disclosure;

FIG. 8 is a cross-sectional view illustrating a touch OLED display according to yet another embodiment of the present disclosure;

FIG. 9 is a cross-sectional view illustrating a touch LCD according to yet another embodiment of the present disclosure.

### DETAILED DESCRIPTION OF THE INVENTION

The disclosure discloses an optical film and a touch controlled display apparatus using the same to save the components and the manufacturing cost for forming the touch controlled display apparatus, as well as to improve the display quality thereof. A number of exemplary embodiments are disclosed below with detailed descriptions and accompanying drawings.

It is understood that the embodiments and methods disclosed below are not for limiting the disclosure. The disclosure can also be implemented by using other technical features, components, methods and parameters. The exemplary embodiments of the present disclosure are for illustrating technical features of the disclosure only, not for limiting the scope of protection of the present disclosure. Based on the descriptions of the specification, anyone who is skilled in the technology field will be able to make necessary modifications or variations without violating the spirit of the present disclosure. Common reference numerals are used throughout the drawings and embodiments to indicate the same component.

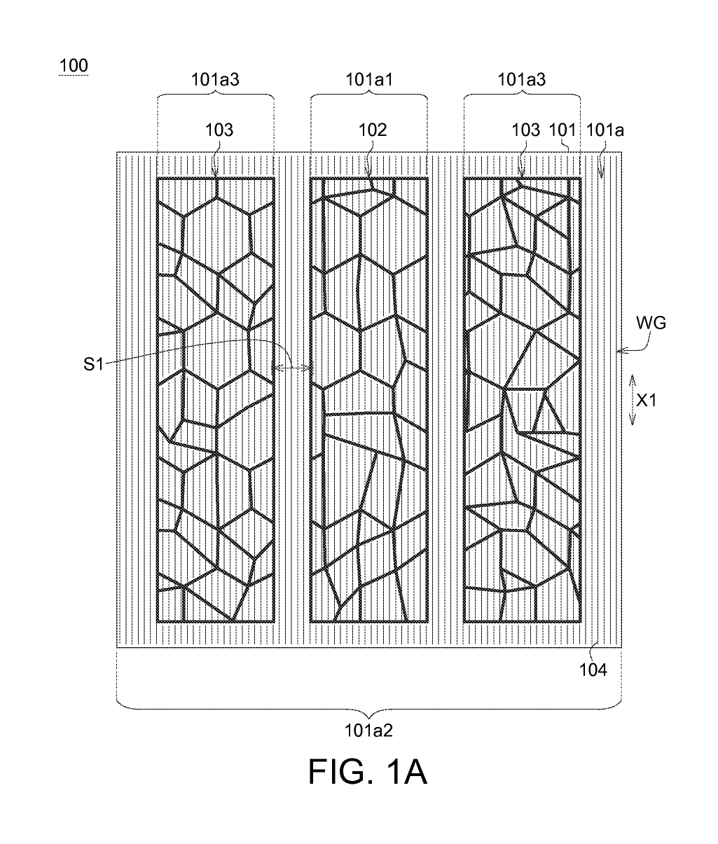

Refer to FIG. 1A to FIG. 1C, FIG. 1A is a top view illustrating an optical film 100 used in a touch controlled display apparatus 1 according to an embodiment of the present disclosure. FIG. 1B illustrates a cross-sectional view of the optical film 100 taken along a tangent line S1 depicted in FIG. 1A. FIG. 1C is a partial enlarged view illustrating in detail the structure depicted in FIG. 1A. The optical film 100 includes a substrate 101 capable of transmitting light, a first electrode 102, a second electrode 103 and a plurality of parallel conductive wires 104.

In some embodiments of the present disclosure, the substrate 101 can be realized by a film or plate board formed of a transparent material such as glass, resin, or polyimide (PI) film. The substrate 101 has a substrate surface 101a. The substrate surface 101a has a transparent region that can be divided into a first area 101a1, a second area 101a2 and a third area 101a3 adjacent to one another. The first electrode 102 is disposed in the first area 101a1. The second electrode 103 is disposed in the third area 101a3. A plurality of parallel conductive wires 104 are disposed in the second area 101a2.

In some embodiments of the present disclosure, the first electrode 102, the second electrode 103 and the parallel conductive wires 104 are adjacent to one another, and the first electrode 102 and the second electrode 103 are insulated from each other. The first electrode 102 and the second electrode 103 can respectively be formed of a metal mesh structure. The “metal mesh structure” is a staggered grid structure composed of tiny wires formed of a conductive material containing metal element. In the present embodiment, the metal mesh structures used for forming the first electrode 102 and the second electrode 103 respectively have a width (W) substantially ranging from 1˜30 micrometers (μm) and preferably ranging from 3˜10 μm. The metal mesh structure can also be formed of indium tin oxide (ITO), metal, such as gold, silver, copper, aluminum, zinc or a combination thereof, or other conductive materials. The pattern of the metal mesh can be a regular or irregular pattern consisting of a plurality of pattern units shaped as triangle, quadrilateral, polygon, circle, ellipse or other possible shapes or the combinations thereof.

A plurality of parallel conductive wires 104 interpose the part of the substrate surface 101a not covered by the metal mesh structure. In the present embodiment, the first area 101a1 of the substrate surface 101a is the area covered by the metal mesh structure used to form the first electrode 102; the third area 101a3 is the area covered by the metal mesh structure used to form the second electrode 103; the second area 101a2 is the remaining space on the substrate surface 101a other than the first area 101a1 and the third area 101a3 (as indicated in FIG. 1A). In other words, the second area 101a2 may include blank areas of the metal mesh structure for isolating the first electrode 102 and the second electrode 103, and include the space restively defined by the metal mesh structures inside the first electrode 102 and the second electrode 103. Therefore, a part of the parallel conductive wires 104 may be disposed on the peripheral of the first electrode 102 and a second electrode 103, another part of the parallel conductive wires 104 may be disposed between the first electrode 102 and the second electrode 103, and yet another part of the parallel conductive wires 104 may be disposed inside the metal mesh structure used to form the first electrode 102 and the second electrode 103.

In an embodiment of the present disclosure, the parallel conductive wires 104 form a wire grid structure WG on the substrate surface 101a. Similarly, the parallel conductive wires 104 can also be formed of indium tin oxide (ITO), metal, such as gold, silver, copper, aluminum, zinc or a combination thereof, or other conductive materials. In the present embodiment, the parallel conductive wires 104 are preferably formed of aluminum. Besides, the parallel conductive wires 104 forming the wire grid structure WG can be formed before, after or at the same time with the formation of the metal mesh structure used for forming the first electrode 102 and the second electrode 103.

Of the parallel conductive wires 104 forming the wire grid structure WG, a distance (b), the pitch (P) between two adjacent parallel conductive wires 104 can be the same or different. Moreover, the width (a) of each parallel conductive wire 104 can be the same or different. In some embodiments of the present disclosure, the pitch (P) between two central points (k) of two adjacent distance (b) substantially ranges from 50˜300 nm. In present embodiment, the distance (b) is substantially equal to the pitch (P). The duty cycle is defined by the width (a) of each parallel conductive wire 104 and the distance (b) adjacent to the parallel conductive wire 104 as a/(a+b) substantially ranging from 0.3˜0.7. In the present embodiment, each parallel conductive wire 104 has substantially the same width (a), and the distance (b) defined by two adjacent parallel conductive wires 104 is substantially the same. The width (a) of the parallel conductive wire 104 preferably ranges from 50˜100 nm. The distance (b) defined by adjacent parallel conductive wires 104 preferably ranges from 50˜100 nm. The thickness (h) of the parallel conductive wire 104 is preferably the same with the thickness of the first electrode 102 and the thickness of the second electrode 103, (but is not limited thereto) and substantially ranges from 50˜250 nm.

Since the pitch P of the wire grid structure WG is substantially equivalent to or less than a half of a visible wavelength (for example, the wavelength of visible light substantially ranging from 400˜800 nm), most of the light with the electric field vector parallel to the light reflection axis X1 of the wire grid structure WG (that is, the arrangement direction of the parallel conductive wires 104) can be thus reflected, and only the light with the electric field vector perpendicular to the light reflection axis X1 of the wire grid structure WG is allowed to pass there through. Therefore, the optical film 100 can be used as a reflective polarizer.

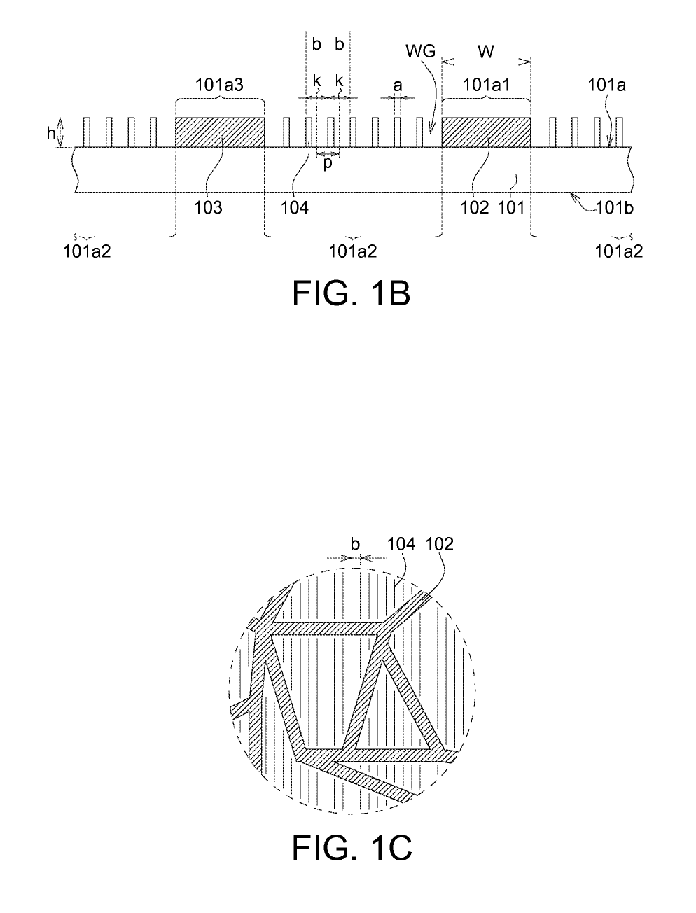

Because the first electrode 102 and the second electrode 103 of the optical film 100 are disposed adjacent and insulated from each other. With suitable pattern design, the first electrode 102 and the second electrode 103 can be used to serve as sensing electrodes of a touch panel in a manner of defining a touch region 11a including a first area 101a1, a second area 101a2 and a third area 101a3 on the substrate surface 101a. After a passivation layer 105 made of a dielectric material is covered on the optical film 100 and a driving circuit and a read circuit (not shown) are integrated there with a touch panel 11 can be formed (referring to FIG. 2). When a finger touches the surface of the touch region 11 a of the touch panel 11, the electric field between the first electrode 102 and the second electrode 103 will be affected and the capacitance of the capacitor structure composed of the first electrode 102 and the second electrode 103 will be changed accordingly. Then, the touch point can be positioned by detecting variation in capacitance.

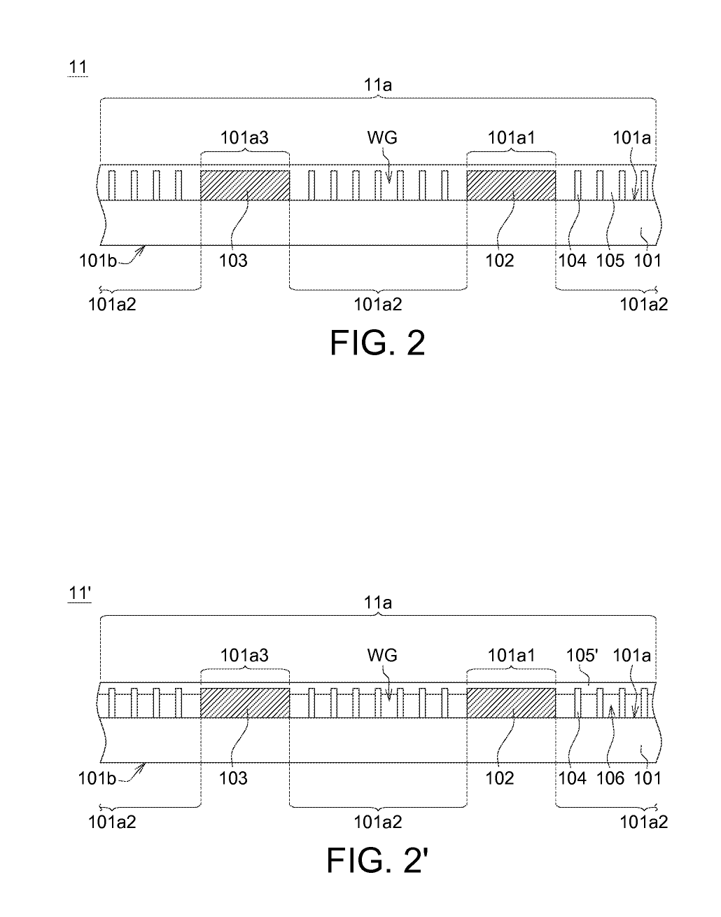

The touch panel 11 can be integrated with a display medium, such as a liquid crystal panel, to form a touch LCD 1. Referring to FIG. 3, FIG. 3 is a cross-sectional view illustrating a touch LCD 1 according to an embodiment of the present disclosure is shown. The touch LCD 1 includes a liquid crystal panel 10, a polarizer 12, a surface light source 13 and a touch panel 11. The liquid crystal panel 10 has a light incident surface 10a and a light output surface 10b. The light output surface 10b of the liquid crystal panel 10 is parallel to the substrate 101 of the touch panel 11. In the present embodiment, a surface 101b of the touch panel 11 opposite to the substrate surface 101a is mounted on the light output surface 10b of the liquid crystal panel 10. The surface light source 13, such as a backlight module, faces the light incident surface 10a of the liquid crystal panel 10, and the polarizer 12 is disposed between the surface light source 13 and the light incident surface 10a of the liquid crystal panel 10.

In an embodiment of the present disclosure, the polarizer 12 can be realized by a reflective polarizer or an absorbing polarizer. When the polarizer 12 is realized by an absorbing polarizer, the light absorption axis of the polarizer 12 (not illustrated) is perpendicular to light reflection axis X1 of the wire grid structure WG of the touch panel 11. When the polarizer 12 is realized by a reflective polarizer, the light reflection axis of the polarizer 12 (not illustrated) is perpendicular to the light reflection axis X1 of the wire grid structure WG of the touch panel 11. Of the incident light provided by the surface light source 13, only the linear polarized light perpendicular to the light absorption axis (or light reflection axis) of the polarizer 12 can pass through the polarizer 12 and enter the liquid crystal panel 10 via the light incident surface 10a. By turning on/off the liquid crystal panel 10 to control the polarized direction of the light emitting from the light output surface 10b and passing through the optical film 100, image display can be accomplished through the touch panel 11.

Because the optical film 100 of the touch panel 11 can both provide a touch sensing function and reflect the polarized light, It can be used serving as a polarizer of the liquid crystal display. After the touch panel 11 is integrated with the liquid crystal panel 10, the touch panel 11 can achieve the same display quality as the touch controlled display apparatus using absorption type polarizer according to the generally known technology without utilizing an additional polarizer disposed outside the light output surface 10b of the liquid crystal panel 10. Accordingly, the touch panel 11 using the optical film 100 saves components and reduces the thickness of the touch LCD 1. Furthermore, in comparison to the absorbing polarizer having high polarized reflectance, the reflective polarizer implemented by the optical film 100 is less likely to absorb the light or develop thermal degeneration, and can therefore assure the display quality of the touch LCD 1.

To further reduce the thickness of the touch LCD 1, in some embodiments of the present disclosure, the passivation layer 105 of the touch panel 11 can be replaced by a translucent tape (glue) which directly attaches the optical film 100 onto the glass substrate (not illustrated) on the light incoming surface 10a of the liquid crystal panel 10. Or, the glass substrate (not illustrated) with the light output surface 10b of the liquid crystal panel 10 can be used as the substrate 101 of the optical film 100, and the first electrode 102, the second electrode 103 and the wire grid structure WG can be directly formed on the glass substrate.

In the present embodiment as indicated in FIG. 2, the passivation layer 105 is completely interposed in the distance between two adjacent parallel conductive wires 104 and the distance between the parallel conductive wires 104 and the first electrode 102 or the second electrode 103. However, in another embodiment of the present disclosure, the passivation layer 105′ of the touch panel 11′ is partially interposed in the distance between two adjacent parallel conductive wires 104 and the distance between the parallel conductive wires 104 and the first electrode 102 or the second electrode 103. That is, some distance 106 between two adjacent parallel conductive wires 104 and between the parallel conductive wires 104 and the first electrode 102 or the second electrode 103 is not interposed by the passivation layer 105′ (as indicated in FIG. 2′).

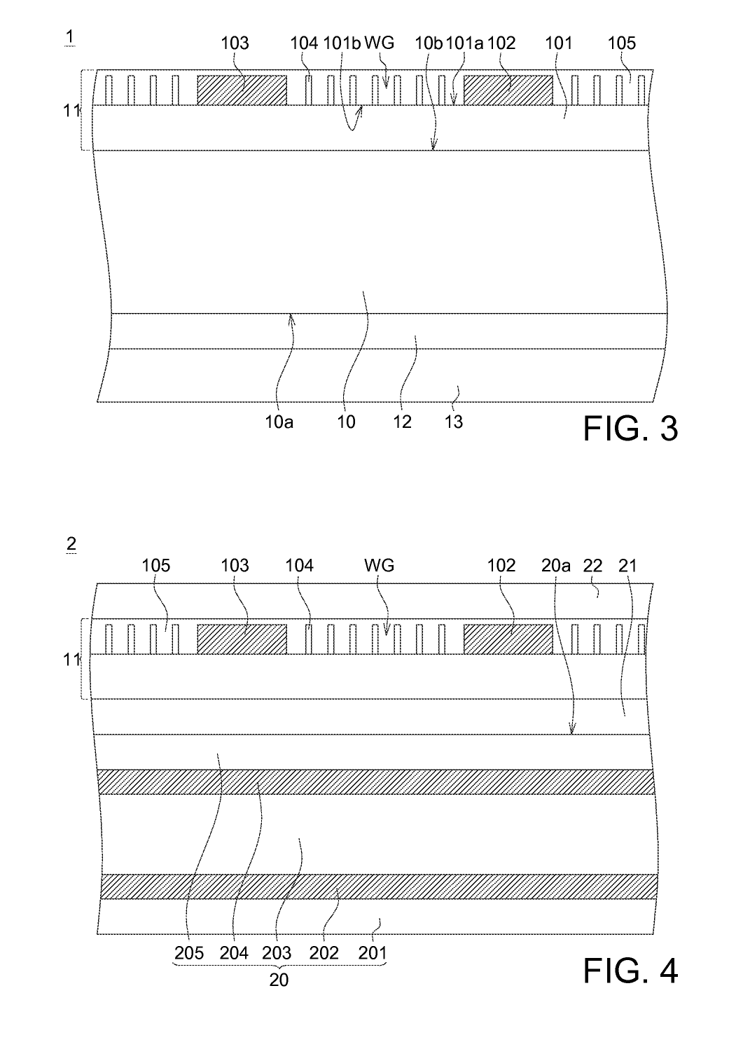

Besides, the touch panel 11 can also be integrated with other display medium, such as an organic light emitting display (OLED) panel 20, to form a touch OLED display 2. Referring to FIG. 4, FIG. 4 is a cross-sectional view illustrating a touch OLED display 2 according to another embodiment of the present disclosure is shown. The OLED display 2 includes an OLED display panel 20, a phase-retardation plate 21, the touch panel 11 and an absorbing polarizer 22.

In the present embodiment, the OLED display panel 20 includes a lower substrate 201, an anode electrode layer 202, an organic light emitting layer 203, a cathode electrode layer 204 and an upper substrate 205. The OLED display panel 20 has at least a light output surface 20a. The touch panel 11 faces the light output surface 20a of the OLED display panel 20. The phase-retardation plate 21 is disposed between the touch panel 11 and the light output surface 20a. The touch panel 11 is also disposed between the phase-retardation plate 21 and the absorbing polarizer 22. Through the optical function of the absorbing polarizer 22, the phase-retardation plate 21, and the optical film 100 of the touch panel 11, the reflection of external light source (not illustrated) can be reduced, so that the contrast of the touch OLED display 2 can maintain at an optimum or preferred level. In some other embodiments, the absorption type polarizer 22 can be omitted and the touch OLED display 2 can be formed as a mirror display.

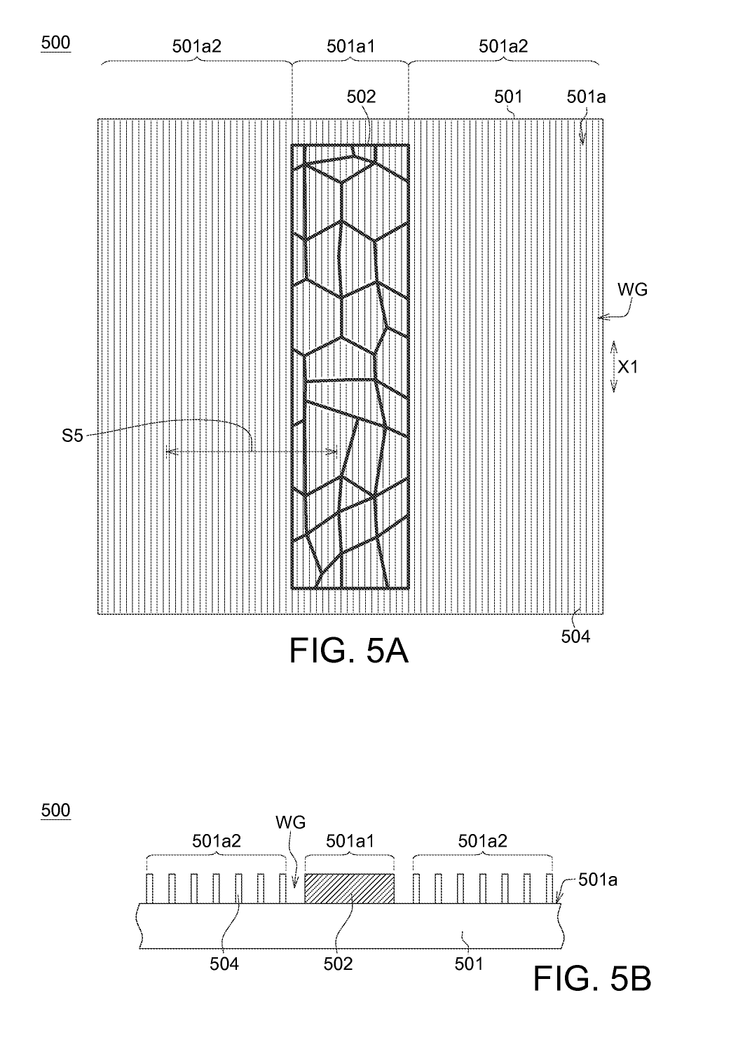

Refer to FIG. 5A and FIG. 5B. FIG. 5A is a cross-sectional view illustrating an optical film 500 used in a touch controlled display apparatus according to another embodiment of the present disclosure. FIG. 5B illustrates a cross-sectional view of the optical film 500 taken along a tangent line S5 depicted in FIG. 5A. The structure of the optical film 500 basically is similar to that of the optical film 100 of FIG. 1A excepts that the optical film 500 only includes a light transmitting substrate 501, a first electrode 502 disposed in the first area 501a1 on the surface 501 a of the substrate 501 and a plurality of parallel conductive wires 504 disposed in the second area 501a2 on the substrate surface 501a, but not include any second electrodes. In the present embodiment, the first electrode 502 can be realized by a metal mesh structure; the portion of the substrate surface 501 a covered by the metal mesh structure for forming the first electrode 502 can be referred to as the first area 501a1 of the substrate surface 501a; and the remaining portion of the substrate surface 501a1 other than the first area 501a can be referred to as the second area 501a2. The parallel conductive wires 504 and the first electrode 502 are separated from each other and together form a wire grid structure WG on the substrate surface 501a. The materials, sizes and formation methods of the metal mesh structure and the wire grid structure WG are the same as the above disclosure, and are not repeatedly described here.

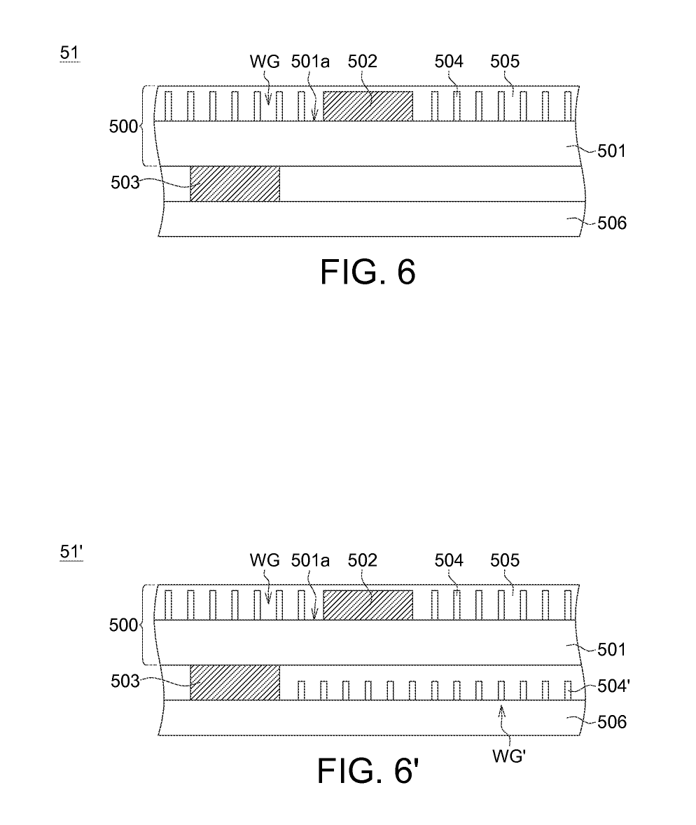

With suitable pattern design, the optical film 500 can be integrated with a driving circuit (TX) and a sensing circuit (RX) (not illustrated) to form a touch panel 51. Referring to FIG. 6, FIG. 6 is a cross-sectional view illustrating a touch panel 51 according to another embodiment of the present disclosure is shown. The touch panel 51 includes a substrate 506, a second electrode 503, an optical film 500 and a passivation layer 505. The second electrode 503 is disposed on the substrate 506. The optical film 500 is disposed on the second electrode 503. Through the substrate 501 of the optical film 500, the first electrode 502 and the wire grid structure WG of the optical film 500 are insulated from the second electrode 503. The passivation layer 505 covers the first electrode 502 and the wire grid structure WG. When the surface of the touch panel 51 is touched by a finger, the electric field between the first electrode 502 and the second electrode 503 will be affected, and the capacitance of the capacitor structure composed of the first electrode 502 and the second electrode 503 will be changed accordingly. Then, the touch point can be positioned by detecting variation in capacitance.

In some other embodiments of the present disclosure, a plurality of parallel conductive wires 504′ similar to the parallel conductive wires 504 of the optical film 500 can be additionally disposed on the substrate 506 of the touch panel 51′ to form a wire grid structure WG′ (as indicated in FIG. 6′) on the substrate 506. The parallel conductive wires 504′ can be aligned or staggered with the parallel conductive wires 504 in parallel and have the function of reflecting polarized light.

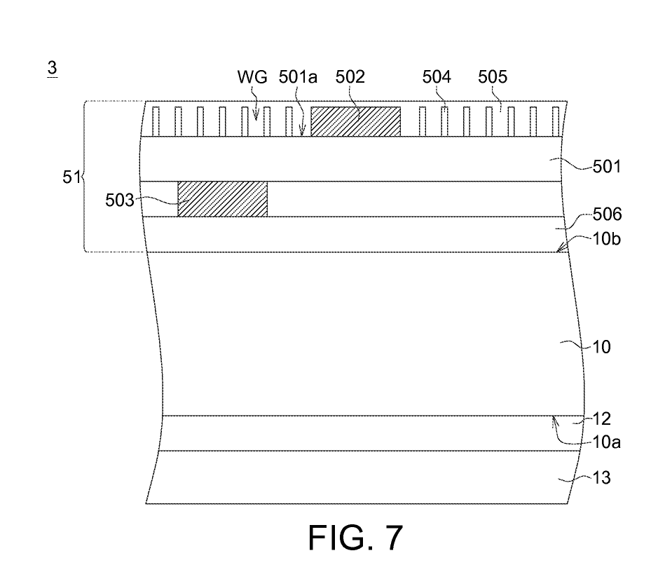

The touch panel 51 can be integrated with the liquid crystal panel 10 to form a touch LCD 3. Referring to FIG. 7, FIG. 7 is a cross-sectional view illustrating a touch LCD 3 according to yet another embodiment of the present disclosure is shown. The structure of the touch LCD 3 basically is similar to that of the touch LCD 1 of FIG. 3 except that the touch panel used in the touch LCD 1 is different from that used in the touch LCD 3. In the present embodiment, the substrate 506 of the touch panel 51 is directly attached on the glass substrate (not illustrated) with the light output surface 10b of the liquid crystal panel 10. The materials, components and formation method of the touch LCD 3 are the same as above disclosure, and are not repeatedly described here.

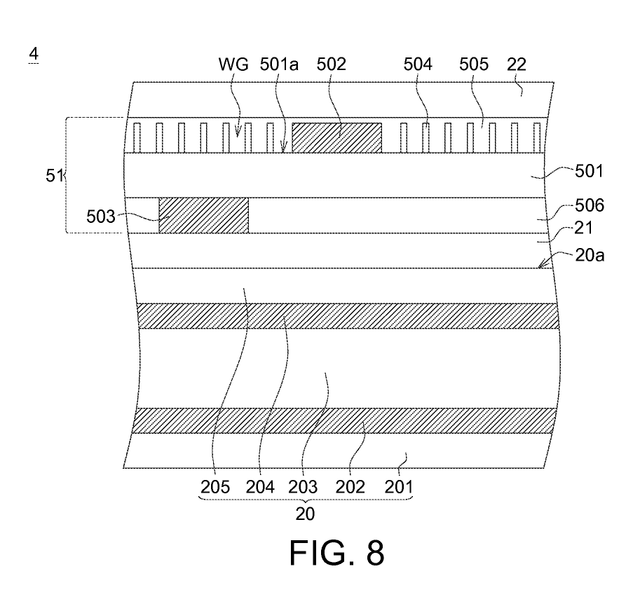

Furthermore, the touch panel 51 can be integrated with the OLED panel 20 to form a touch OLED display 4. Referring to FIG. 8, FIG. 8 is a cross-sectional view illustrating a touch OLED 4 display according to yet another embodiment of the present disclosure is shown. The structure of the touch OLED display 4 basically is similar to that of the touch OLED display 2 of FIG. 4 except that the touch panel used in the touch OLED displays 2 is different from that used in the touch OLED displays 4. In the present embodiment, the phase-retardation plate 21 faces the light output surface 20a. The touch panel 11 is also disposed between the phase-retardation plate 21 and the absorption type polarizer 22. The materials, components and formation method of the touch OLED display 4 are the same as above disclosure, and are not repeatedly described here.

Because the optical film 500 of the touch panel 51 has the function of reflecting polarized light, it can be used serving as a reflective polarizer. The first electrode 502 of the optical film 500 can also be used serving as a sensing electrode of the touch panel 51. Therefore, after the touch panel 51 is integrated with the liquid crystal panel 10 or OLED panel 20, the resulted touch LCD 3 or the touch OLED display 4 can achieve the same display quality as the touch controlled display apparatus using absorbing polarizer according to the generally known technology without utilizing an additional polarizer disposed outside the light output surface 10b or 20a of the liquid crystal panel 10 or the OLED panel 20. Thus, the touch panel 51 using the optical film 500 can save components and reduces the thickness of the touch LCD 3 or the touch OLED display 4. Furthermore, in comparison to the absorbing polarizer implemented by the by the optical film 500 having high polarized reflectance, the reflective type polarizer is less likely to absorb the light or develop thermal degeneration, and can therefore assure the display quality of the touch LCD 3 or the touch OLED display 4.

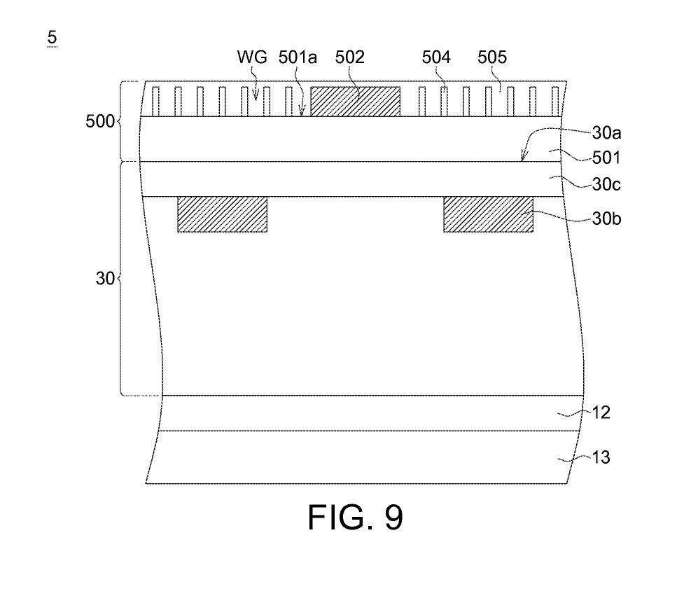

Apart from the above design, the optical film 500 of FIG. 5A and FIG. 5B can also be individually integrated with a liquid crystal panel to form a liquid crystal panel 30 having a touch-sensing function. The liquid crystal panel 30 can further be integrated with the polarizer 12 and the surface light source 13 to form another touch LCD 5. Referring to FIG. 9, FIG. 9 is a cross-sectional view illustrating a touch LCD 5 according to yet another embodiment of the present disclosure.

In the present embodiment, the first electrode 502 of the optical film 500 and a portion of the driving circuit element 30b (such as common electrode) disposed on the glass substrate 30c of the liquid crystal panel 30 can respectively be used serving as a driving circuit (TX) and a sensing circuit (RX) (not illustrated), such that the liquid crystal panel 30 can have a touch-sensing function. The light output surface 30a of the liquid crystal panel 30 is disposed between the first electrode 502 and the driving circuit element 30b. The first electrode 502 is insulated from the driving circuit element 30b through the substrate 501 of the optical film 500 and the glass substrate 30c of the liquid crystal panel 30.

According to the above disclosure, the embodiments of the present disclosure discloses an optical film having a nano wire grid structure and a touch controlled display apparatus using the same. The sensing electrodes of the touch panel are integrated into the optical film having the nano wire grid structure, such that the optical film can both provide a touch-sensing function and reflect polarized light. In other words, the optical film can serve as a touch panel element and a reflective polarizer of a display medium included in the touch controlled display apparatus at the same time.

When the touch panel using the optical film is integrated with the display medium to form a touch controlled display apparatus, a conventional polarizer disposed outside the light output surface of the display medium can be omitted. Such that, not only the manufacturing cost for forming the touch controlled display apparatus but also the thickness of the touch controlled display apparatus can be reduced by omitting the use of the polarizer. Furthermore, because the optical film having the nano wire grid structure is a reflective polarizer that, in comparison to an absorbing polarizer, has a polarized reflectance greater than that of the absorbing polarizer. The optical film having the nano wire grid structure is less likely to absorb the light to develop thermal degeneration, and can therefore assure the display quality of the touch controlled display apparatus.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical film, comprising:
a substrate having a transparent region, wherein the transparent region has a first area and a second area;
a first electrode disposed in the first area and having a width substantially ranging from 1˜30 micrometers (μm); and
a plurality of parallel conductive wires disposed in the second area, wherein at least two adjacent parallel conductive wires have a distance substantially ranging from 5˜300 nanometers (nm).

2. The optical film according to claim 1, further comprising a second electrode disposed in a third area of the transparent region, wherein the third area is disposed adjacent to the first area and the second area, and the second electrode and the first electrode are insulated from each other.

3. The optical film according to claim 1, wherein the pitch of the parallel conductive wires is substantially equivalent to or less than a half of a visible wavelength.

4. The optical film according to claim 1, wherein each parallel conductive wire has a width, and the width and the distance of the corresponding parallel conductive wire define a duty cycle substantially ranging from 0.3 to 0.7.

5. A touch controlled display apparatus, comprising:
an optical film, comprising:
a substrate having a surface, wherein the surface has a touch region comprising a first area and a second area;
a first sensing electrode disposed in the first area, wherein the first sensing electrode has a width substantially ranging from 1˜30 μm; and
a plurality of parallel conductive wires disposed in the second area, wherein at least two adjacent parallel conductive wires have a distance substantially ranging from 5˜300 nm; and
a display medium having a light output surface parallel to the surface.

6. The touch controlled display apparatus according to claim 5, further comprising a polarizer, wherein the polarizer faces a light incident surface of the display medium and has a first light reflection axis, and the parallel conductive wires form a wire grid structure having a second light reflection axis perpendicular to the first light reflection axis.

7. The touch controlled display apparatus according to claim 5, further comprising a second sensing electrode disposed in a third area of the surface, wherein the third area is adjacent to the first area and the second area, and the second sensing electrode and the first sensing electrode are insulated from each other.

8. The touch controlled display apparatus according to claim 5, wherein the pitch of the parallel conductive wires is substantially equivalent to or less than a half of a visible wavelength.

9. The touch controlled display apparatus according to claim 5, wherein each parallel conductive wire has a width, and the width and the distance of the corresponding conductive wire define a duty cycle substantially ranging from 0.3 to 0.7.

10. The touch controlled display apparatus according to claim 7, wherein the light output surface is disposed between the first sensing electrode and the second sensing electrode, and the first sensing electrode and the second sensing electrode are insulated from each other.
